(19) United States
(12) Patent Application Publication
(10) Pub. No.: US 2006/0123993 A1
(43) Pub. Date: Jun. 15, 2006

(54) System for drying gas and use of the system

(76) Inventor: Norolf Henriksen, Notodden (NO)

Correspondence Address: WENDEROTH, LIND & PONACK, L.L.P., 2033 K STREET N. W., SUITE 800, WASHINGTON, DC, 20006-1021, US

(21) Appl. No.: 10/546,915

(22) PCT Filed: Mar. 26, 2004
(86) PCT No.: PCT/NO04/00089

§ 371 Date: Dec. 29, 2005

(30) Foreign Application Priority Data
Mar. 28, 2003 (NO) 20031458

(51) Int. Cl. B01D 53/14

(52) U.S. Cl. 96/234

(57) ABSTRACT

A system for drying gas, for example removing moisture (water) from natural gas in connection with the extraction of oil and gas, comprising a drying unit for drying the gas by means of a drying liquid that is mixed with the gas and a regeneration unit (C) that regenerates the gas. The drying unit comprises one or more processing stages (A, B) where each stage comprises a mass transfer unit in the form of a static mixer unit or pipe loop (2) in which the gas is mixed with the drying liquid and passed in the direction of flow of the drying liquid to a gas/liquid separator (3), and where the gas is designed to be passed on the next stage (B) or on to an outlet (6), while the drying liquid is passed to the regeneration unit (C) and/or to the mass transfer unit (2) for the relevant processing stage(s) (A and/or B).

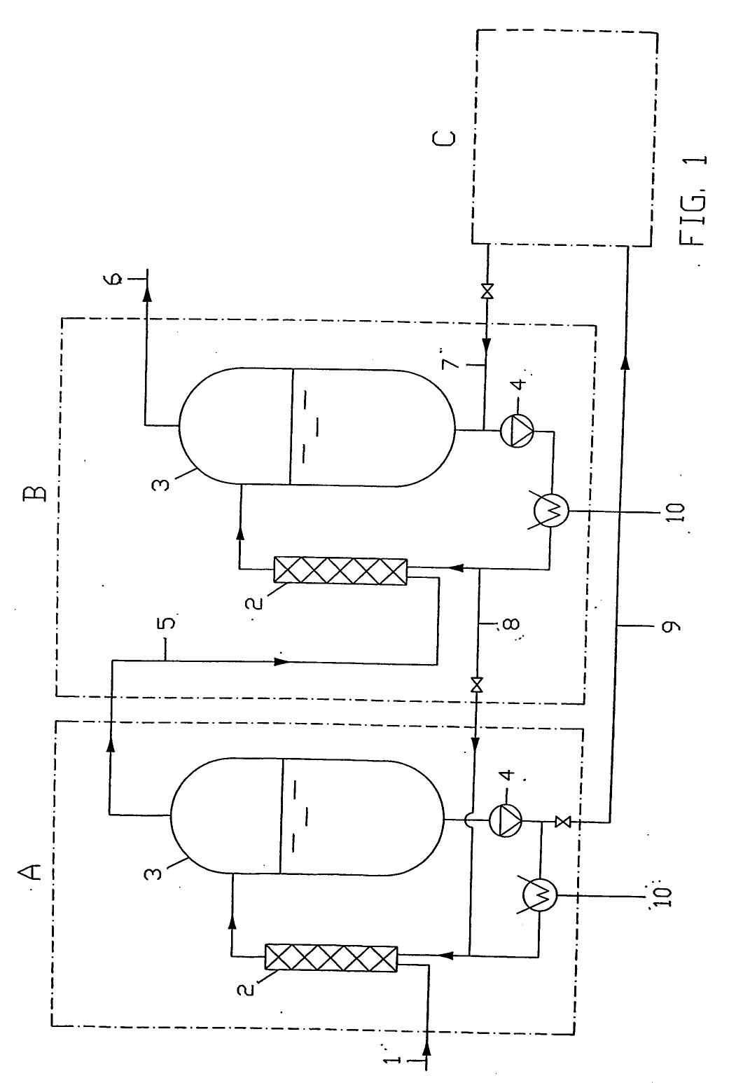

The present invention concerns a system for drying gas, for example removing moisture (water) from natural gas in connection with the extraction of oil and gas, comprising a drying unit for drying the gas by means of a drying liquid that is mixed with the gas and a regeneration unit that is designed to regenerate the gas.

Natural gas that is extracted from oivgas fields at relatively high pressure is usually saturated with water vapour. The water content in the gas can create considerable problems when it is transported through pipelines. When the gas cools, the water vapour condenses and may subsequently freeze, blocking the pipelines with ice crystals.

If the gas is compressed and subsequently cooled, the same occurs. The water may also react with hydrocarbons and create ice hydrate, which may also block valves and pipelines.

For these reasons, it is necessary for the gas to be extracted to undergo a drying process before it is transported through long pipelines, which are laid on the sea bed, to its destination, which may be a store, processing plant or similar. In such a drying process, the quantity of water vapour in the gas must be reduced to such an extent that there is no risk of water being condensed during transport and freezing to form ice.

The most common drying process involves a liquid with a good capacity for absorbing water vapour being brought into intimate contact with the gas and thus drying the gas. The liquid used, which will be virtually saturated with water, is regenerated in order to be reused by being made water-free again by means of a form of boiling process. A number of such liquids are commercially available. The requirements made of such a drying or absorption liquid include the following:
it must be very hygroscopic
it must not become solid as a concentrated liquid
it must not bond with components in the natural gas
it must be easy to regenerate it to remove the absorbed water
it must be stable in the presence of sulphur components or CO₂

A number of types of glycol come close to meeting the above requirements, including diethylene (DEG), triethylene (TEG) and tetraethylene (TREG).

However, TEG is almost the only type used for this purpose.

In the drying systems used as standard, the water absorption process takes place in vertical columns or towers with bases, or filled with filling bodies (Raschig rings), in which a counterflow system is used, i.e. the gas to be dried flows up through the column or tower, while the drying agent, for example TEG, flows down over bases or filling bodies and absorbs water vapour.

In order to achieve a sufficient degree of drying of the gas in such a tower, the tower must be very high. Moreover, to avoid unfortunate phenomena such as flooding and the like, the diameter of the column/tower must be adjusted relatively precisely. A conventional drying system therefore has relatively large dimensions and is not well suited for use on production ships, for example.

The present invention represents a drying system for gas that takes up little space, weighs little and has a low height compared with conventional drying towers. The system in accordance with the present invention will not be sensitive to sea swell either and will therefore be well suited for production ships.

Furthermore, the solution in accordance with the present invention is designed to withstand high external pressures, which means that it can be used in connection with submarine installations in connection with, for example, the separation of oil, gas and water. In such situations, the regeneration unit may expediently be placed on a local platform or ship for practical reasons.

Like the conventional solutions, the present invention is also based on the use of a liquid, for example TEG, as the drying medium. Unlike the conventional processes, in which the mass transfer of water vapour from the gas to the drying medium takes place in towers/columns in which the gas and liquid flow in opposite directions to each other, the present invention is based on the mass transfer taking place in a co flow system. Such a system may comprise one or more processing stages. The present invention is characterised in that the drying unit comprises one or more processing stages, where each stage comprises a mass transfer unit in the form of a static mixer unit or pipe loop in which the gas is mixed with the drying liquid and passed in the direction of flow of the drying liquid to a gas/liquid separator, and where the gas is designed to be passed on to the next stage or on to an outlet, while the drying liquid is passed to the regeneration unit and/or to the next stage, as specified in the attached claim 1.

It has proved to be very advantageous to have a large quantity of drying liquid circulate internally in a processing stage, while only a relatively small quantity of drying liquid is passed out of/into the stage (equivalent to the quantity of drying liquid used in conventional drying towers). In this situation, a high degree of theoretical equilibrium between the water vapour content of the gas and the drying liquid is achieved, i.e. the drying process is very effective. Operated in this way, the process is so effective that, in most cases, one processing stage is sufficient to achieve the desired dryness of the gas.

The process also makes it possible to install coolers 10 to cool the circulating drying liquid and thus to cool the gas indirectly. Keeping the drying liquid cool also increases its water vapour absorption capacity.

Systems built in this way thus have a much smaller volume than conventional drying systems for gas based on counterflow drying towers. The systems are not sensitive to foaming either, unlike conventional drying towers.

Each stage therefore consists of a mass transfer unit, a separator for gas/drying medium and a pump for circulation of the drying liquid or drying medium.

The mass transfer unit in which water vapour is transferred from the gas to the drying medium may be designed, for example, as vertical sling pipes or static mixers integrated in vertical tubular housings. The function of the separator for gas/drying liquid is to separate the drying liquid from the gas so that the drying liquid can be recirculated back to the mass transfer unit using a pump. The quantity of liquid circulated in each stage may be determined using an optimisation assessment.

The process also aims for the quantity of liquid regenerated in relation to the quantity of gas processed to be as in conventional drying systems. This makes it possible to continue to use existing regeneration systems after a conventional system, based on counterflow, has been removed and a co-flow system in accordance with the present invention has been expediently installed as a replacement.

The present invention will be described in further detail in the following by means of examples and with reference to the attached drawing, which shows a 2-stage system in which the use of static mixers 2 is indicated for mass transfer, i.e. transfer of water vapour (in the gas to be dried) to the drying liquid. The process shown in the figure comprises two stages, A and B, and, in addition to the static mixers 2, the main elements in each of the two processing stages are a gas/liquid separator 3 and a circulation pump for liquid 4. The gas flows, propelled by its own pressure, from a relevant gas source (not shown) to an inlet 1 of a first static mixer 2, where it is mixed with drying liquid and passed on in the direction of flow of the drying liquid to a first gas/liquid separator 3 in the first stage, A, in the system. From the gas/liquid separator 3 in the first stage, A, the gas is passed on to a second static mixer 2, where it is mixed with drying liquid and passed on in the direction of flow of the drying liquid to a second gas/liquid separator 3 in the second stage, B, and from there, as dried gas mainly free of moisture (water) to an outlet 6 for transport to a store, processing plant or similar (not shown).

Drying liquid containing water, for example TEG, is removed from the first stage, A, and passed to a regeneration unit C. After regeneration, the liquid is passed back to the drying system through a pipe 7 to the static mixer 2 in the second processing stage, B, and via a pipe 8 to the static mixer 2 in the first processing stage, A. Circulation pumps 4, which circulate the drying liquid in the system, are arranged at the outlets of each of the gas/liquid separators 3. In the system shown in the figure, the pumps 4 are arranged in such a way that the drying liquid from the regeneration unit C is mixed with the drying liquid from the gas/liquid separator 3 in stage B before distribution to the respective static mixers 2, while the drying liquid from the gas/liquid separator in stage A is partially passed back to the regeneration unit C and partially back to the static mixer 2 in stage A.

With this solution, where the liquid is drawn partially from the regeneration unit C and partially from the relevant gas/liquid separator, and with a high-capacity pump, higher circulation of drying liquid through the separator(s) is achieved with resulting higher mass transfer in the static mixers/pipe loops.

In this case, the process is also based on a certain pressure drop being acceptable for the gas. Therefore, there is no need for a compressor.

Moreover, the pumps for each stage are dimensioned for optimal mass transfer in the static mixers.

The present invention as it is defined in the following claims is not limited to the embodiment shown in the figure and described above. Therefore, instead of static mixers, sling pipes may be used. In a system in which sling pipes are used, the structure may expediently otherwise be identical to that which is shown in the figure and described above.

The system is intended to use the same quantity of regenerated drying liquid as a conventional: drying tower, i.e. the same type and size of regeneration system may be used.

A co-flow system of the above type was tested at a test centre for process technology.

Test A

The number of stages in the system was 2, and sling pipes were used for mass transfer instead of static mixers. The internal diameter of these pipes was 25 mm. 2 sets of such pipes with a vertical height of 10 metres and a total pipe length per stage of 40 metres were used for each stage.

The remaining data for the test was:

| | |
|---|---|
| Gas flow rate: | 40 Nm³/h |
| Gas pressure: | 5.5 bar (a) |
| Temperature: | 20° C. |
| Glycol flow rate: | 2.5 l/h MEG (monoethylene glycol) |

In this test, no drying liquid was circulated internally in each stage.

Test B

In this test, a single-stage system with vertical sling pipes for mass transfer was used.

| | |
|---|---|
| Sling pipe height: | approximately 3.2 m |
| Total length of piping: | approximately 19 m |
| flow rate of gas processed: | 20 Nm³/h |
| Gas pressure: | 1 bar g |
| Gas temperature: | 10° C. |
| Glycol flow rate in/out: | 1.31 l/h |
| Glycol flow rate for internal | 15 l/h |
| circulation in the stage: | |
| Water content of the inflow gas: | 5 g/m³ |
| Achieved reduction in water | approximately 95% of the theoretically |
| vapour in the gas: | achievable reduction |

The conclusion for the above tests was that high internal circulation of drying liquid in the stage has a very large positive effect.

Test Results:

First Stage:

| | | |
|---|---|---|
| Gas in: | 1600 ppm H₂O): | water vapour pressure p = 6.6 mm Hg |
| Gas out: | 840 ppm H₂O | water vapour pressure p = 3.52 mm Hg |
| Glycol in: | 0.7% H₂O | water vapour pressure p = 0.4 mm Hg |
| Glycol out: | 1.75% H₂O | water vapour pressure p = 1.3 mm Hg |

Degree of equilibrium, out: 1.3:3.52=0.37

Efficiency (water removed in the stage): approximately 47%

In hindsight, the mass transfer unit in this stage should have had a larger contact area. The efficiency could then have been much higher.

Second Stage:

| | | |
|---|---|---|
| Gas in: | 840 ppm H₂O): | water vapour pressure |
| | | p = 3.52 mm Hg |
| Gas out: | 210 ppm H₂O | water vapour pressure |
| | | p = 0.89 mm Hg |
| Glycol in: | 0.1% H₂O | water vapour pressure |
| | | p = 0.075 mm Hg |
| Glycol out: | 0.7% H₂O | water vapour pressure |
| | | p = 0.4 mm Hg |

Degree of equilibrium, out: 0.4:0.89=0.45

Efficiency (water removed in the stage): approximately 75%

Total efficiency for both stages: approximately 87%. Technical system

On the basis of the test results achieved, it seems clear that a single-stage drying system will meet the requirements normally made for gas drying systems in most cases.

A simple calculation for a specific system produces these results:

Incoming gas:

| | |
|---|---|
| Flow rate: | 10 mill. sm³/day (5000 m³/h) |
| Temperature: | 22° C. |
| Pressure: | 68 bar g |
| Water vapour pressure in gas: | 25 mm Hg |
| Objective: | The gas is to be dried to |
| | dew point −15° C. |

At 22° C., saturated gas contains approximately 17 times as much water vapour as at −15° C. The necessary efficiency for water vapour removal from the gas is then 94%. This is achieved with a single-stage system:

| | |
|---|---|
| with supply of regenerated glycol to the stage: | 320 l/h |
| with circulation of glycol in the stage: | 4000 l/h |

1-9. (canceled)

10. A system for drying gas, for example removing moisture (water) from natural gas in connection with the extraction of oil and gas, comprising a drying unit for drying the gas by means of a drying liquid that is circulated by means of one or more pumps (4) and mixed with the gas and a regeneration unit (C) that regenerates the drying liquid, wherein the drying unit comprises one or more processing stages (A, B), where each stage comprises a mass transfer unit in the form of a static mixer unit or pipe loop (2) in which the gas is mixed with the drying liquid and passed in the direction of flow of the drying liquid to a gas/liquid separator (3), and where the gas is designed to be passed on to the next stage (B) or on to an outlet (6), while the drying liquid is passed to the regeneration unit (C) and/or to the mass transfer unit (2) for the relevant processing stage(s) (A and/or B).

11. A system in accordance with claim 10, wherein the respective stages (A, B) are connected in series.

12. A system in accordance with claim 10, wherein the respective stages (A, B) are connected in parallel.

13. A system in accordance with claim 10, wherein a circulation pump (5) is arranged at the outlet of the gas/liquid container (3) for each stage (A, B).

14. A system in accordance with claim 10, wherein the return pipe (7) from the regeneration unit is connected to the outlet pipe from the gas/liquid separator before the inlet to the pump (4).

15. A system in accordance with claim 10, wherein a cooler (10) is arranged in the circulation circuit for the drying liquid for possible cooling of the liquid and thus also indirect cooling of the gas.

16. A system in accordance with claim 10, wherein the drying liquid is a type of glycol liquid, for example diethylene (DEG), triethylene (TEG) or tetraethylene (TREG).

17. Use of a system in accordance with claim 10 on a vessel or platform.

18. Use of a system in accordance with claim 10 in connection with an installation on the sea bed.
